(19) United States
(12) Patent Application Publication
(10) Pub. No.: US 2019/0262744 A1
(43) Pub. Date: Aug. 29, 2019

(54) Configurable System for the Extraction of Targeted Constituents from Liquids and Gasses

(71) Applicants: Marc Philip Privitera, Walnut Creek, CA (US); Christina Metz Borgese, Walnut Creek, CA (US)

(72) Inventors: Marc Philip Privitera, Walnut Creek, CA (US); Christina Metz Borgese, Walnut Creek, CA (US)

(21) Appl. No.: 16/279,910

(22) Filed: Feb. 19, 2019

Related U.S. Application Data
(60) Provisional application No. 62/635,411, filed on Feb. 26, 2018.

(51) Int. Cl. B01D 15/12; B01D 15/18; B01D 53/02; B01D 53/22; B01D 61/02; B01D 65/08; C01B 32/50

(52) U.S. Cl. CPC B01D 15/125; B01D 15/1871; B01D 53/025; B01D 53/229; B01D 2321/2008; B01D 65/08; C01B 32/50; B01D 2311/12; B01D 2311/2626; B01D 61/025

(57) ABSTRACT

A method for the extraction, purification, and concentration of targeted constituents from a liquid or gas assembled configurable unit operations comprising of an in-situ generation of seeding material for removal of impurities; an extraction process using equipment of predetermined physical geometry; and a membrane concentration method for the recovery of dilute solutions for recycle.

### PRIORITY DATE CLAIM

Provisional Patent Application 62/635,411 is incorporated in this application in its entirety. The priority date of the provisional application is claimed.

### PRIOR ART

Prior art includes the application of materials and systems for extracting and isolating targeted constituents. Examples include U.S. Pat. No. 8,753,594B1, U.S. Pat. No. 6,280,693, U.S. Pat. No. 8,637,428B1, U.S. Pat. No. 5,599,516A, U.S. Pat. No. 8,716,954, U.S. Pat. No. 8,309,043B2, U.S. Pat. No. 5,993,759A.

The invention disclosed in this application improves upon this prior art by presenting unique solutions to the economically disadvantaged extraction effectiveness of the prior disclosed materials and methods. It discloses the advantages over prior art by combining the use of various individual chemical process functions into a system which presents a unique system for the extraction of targeted constituents from liquids and gasses.

### BACKGROUND OF THE INVENTION

In chemical systems that extract targeted constituents from liquids and gasses a series of unit operations are combined to complete a system that addresses the various aspects of the technical details required to complete the system functionality. Usually the feed material contains impurities or other undesired non-targeted constituents that must be removed from the liquid or gas for the system to extract the desired targeted constituents.

The extraction unit is more effective if a sharp “chromatographic” concentration interface is present to increase the mass transfer driving force due to the increased concentration differences between the feed and the material that makes up the packed bed that has an affinity for the targeted constituent. To insure this sharp chromatographic interface front, different fluid distribution and physical equipment geometry is employed in various methods.

The extraction unit operation itself can create several dilute constituent streams that have little or no economic value and if they are recycled in the form from which the exit the extraction unit, will lower the overall capacity of the system due to the dilution factors of the overall flow through the system. Combining into the system a membrane separation unit operation downstream of the extraction unit operation, these streams can be concentrated and be recycled into the feed stream without significantly lowering the dilution of the feed stream to allow the overall flow capacity to be maintained at an economically feasible level

In any packed bed column system, it is desirable to simplify the column sequence, reduce the needed volume, reduce the dynamic shock on the internals components of the system, and makes use of post column concentration methods not available previously in conventional systems.

A stream containing a desired targeted constituent is run through different types of equipment, most commonly a daisy chain of packed bed columns. The targeted constituent is selectively adsorbed onto the internal packing of the packed bed column. The internals made up primarily of treated material in the form described below is operated using a specific sequence set of steps. The sequence of flows is determined to displace various residual streams minimizing impurities and maximizing concentration of the targeted constituent for isolation and separation.

The conventional system performance is limited by the ability to increase the concentration of the targeted constituent and decrease concentration of the undesired impurities. Conventionally, streams dilute in the targeted constituent, but still containing some concentration that is recoverable, must be recycled thus creating specific sequences and column arrangements that require large volume internal components and flow.

Large volume internal components may include sorbent particles, sorbent fibers, separation membranes, plates, and other known separation materials must be arranged such that a sharp distinct difference in the concentration of the stream flowing through the equipment containing the internals is present to enable the maximum mass transfer driving force of the targeted constituent to the internals. These internals are the extracting materials.

An embodiment of this method could be lithium as an example of a targeted constituent, but the invention is not limited to only lithium as many targeted constituent examples exist.

There are different types of flows into the system. As described above the columns may be in one of the three daisy chain modes, lead, lag, or regeneration. There are also different types of fluid flow depending upon the specific sequence to best extract the targeted constituents. Each of these sequences is unique and novel, and are commonly held as trade secrets” as opposed to being disclosed in patent art.

During “load” flow the stream containing the source of the targeted constituent is directed through first the lead column then the lag column.

There are different measurement terms to control the columns.

Bleed is the concentration of the outlet stream that is unable to be captured by the internal material. A typical value might be 20 mg/kg concentration of the targeted constituent. This is the “baseline” level of the internal material.

Breakthrough is the point at which the concentration of the of the targeted constituent first rises above the bleed level of the outlet flow. This is commonly the point at which the column that is in the lead position is switched to the lag position.

Saturation is when the outlet stream concentration matches the inlet stream concentration of the targeted constituent. This occurs once the internal material has reached a point that all available extraction sites have been filled by the targeted constituent.

A common problem with large diameter columns is that not all available sites are able to be presented with the most advantageous mass transfer conditions due to the possibility of a variable chromatographic front due to mal-distribution. This invention presents a larger concentration gradient at each local site by keeping a sharper concentration profile across the surface area of the flow through the column. This more fully utilizes all sites and increases the capacity of the column, improving performance.

At saturation, the column in lag is switched to regeneration. A second stream, different from the load flow stream is passed through the column to displace the residual liquid from the load flow. This lowers the concentration of impurities and the non-targeted constituents. A third flow, commonly called the strip, comprised of an appropriate constituent concentration make up removes, or strips, the targeted constituent from the internal material of the column. This flow is known as product flow when the concentration of the strip flow is rich in the targeted constituent and can be accomplished using various “stripping” solutions.

The sequence duration and specific makeups of each of these streams determine the performance of the column. In some cases, the feed for the second stream and third flow can be of the same material, however in most cases their resulting discharge is handled differently. In many cases streams of dilute concentration of the targeted constituent are used in the sequence. This requires the equipment to be large volume, therefore affecting the stability of the sharp concentration profile needed to drive mass transfer. Or there must be multiple pieces of the similar equipment to handle the capacity of the overall system. If the various time durations of each of the columns' operations are not within a certain coordinated duration, then there can be significant idle asset time increasing the capital cost of the overall system. There are many other possible sequences including intermediate arrangements of the columns as well. There are also many other methods of extracting the targeted constituents including using the extraction material sites to grab the unwanted impurities. Other sequence steps, not addressed here, but which could be part of the described invention could include other intermediate flow streams in order to refine and optimize the performance of the columns and the internal materials in the packed bed.

### DESCRIPTION OF THE INVENTION

A system for the extraction, purification, and concentration of targeted constituents from a liquid or gas that can be constructed from a series of configurable unit operations including a preparation process using an in-situ generation of seeding material for removal of impurities, an extraction process using specific equipment physical geometry, and membrane concentration of the resulting dilute solutions for recycle and capture of the low concentration targeted constituents.

Targeted constituents are removed by arranging functionally independent, and then as connected in a system, interdependent unit operations, in a specific sequence with specific parameters developed for the targeting the extraction and isolation of characteristic constituents separating them from other non-targeted constituents considering the conditions of the feedstock.

The independent unit operations are fully operational for their described function independently and can be configured into a system when interconnected. Examples may include, but are not limited to distillation systems, liquid solvent extraction systems, ion exchange columns, solid liquid sorbent systems, filter systems, membrane systems, precipitation tank systems, crystallizers, evaporators, and other chemical processing unit operations.

These units can operate from a set of input parameters and a feedstock producing a defined product with a set of characteristics in a form that is then available to proceed downstream to the next unit operation.

This type of arrangement is common in fixed asset chemical processing system, but this invention adds the ability to mix and match or plug and play various fully functional units into a coordinated system is based upon an analogous market concept of the ability to be “hailed”, or “called into service” as is now common with fully functional physical transportation equipment. This invention teaches the concept of the “shared economy” for chemical equipment. This concept can be extended to the financial business process that may be applied to utilize shared assets for the variable production campaign needs of various operations.

An advantage of this type of system is the ability to bring the chemical operational units to the needed processing site versus the more common method of transporting the feedstock to the centrally located chemical plant. In this method, production can be campaigned based upon the schedule of operations and favorable characteristics of the more economically advantageous processing location.

Assets are more fully utilized and allows for the flexibility of calling for equipment where and when it is required.

The ability to bring mobile equipment to the production site is not new, and has been employed in many previous situations, however, the specific mobile equipment unique to the extraction, isolation and concentration of specific targeted constituents like as described in this example, lithium, have not been specifically applied due to limitation of the operational aspects required for the functionality of the system.

To give a conventional example to where this invention may be applied, in conventional methods of separating targeted constituents from liquids and gasses, the system depends upon a specific set of equipment permanently assembled at a specific location. This limitation reduces asset utilization as certain operations are based upon the timing of certain operations only available at the permanent installed asset base site.

The unique ability of this invention to quickly assemble, disassemble and relocate needed unit operations allows the equipment to be brought to the location as needed reducing costs. Other operations at the feedstock location have previously been shown to be relocatable packages of equipment, but the unique nature of the type of equipment has previously made the arrangement of these type of systems limited due to the nature of the materials, equipment and the needed geometry of the equipment that has limited geometric configurations.

The equipment of this invention is designed to fit within the 8.75-foot-high, 8.25 foot wide, 52 foot long dimensions. This requires the equipment, examples may include, but is not limited to, columns, tanks, and other geometry dependent units to be arranged in a pattern to allow the flow of the liquid through the equipment while maintaining the flow capacity volume in the active area of the unit. The valving and the liquid distribution headers must be of a design such that the height is minimized, and the flow is at steady state with no fluid gaps which would allow for physical state of matter changes (i.e. a flowing liquid changing its state in the piping or unit to a gas between units) that would disrupt the function of the unit. The configurable units must be arranged without generating any hydrodynamic impulse disturbances that would contribute to the destruction of the friable or other specific components of the functional units susceptible to degradation while in use. The discharge header on the bottom of the various equipment units makes use of the same flow path for the possible functional backflush of the various units that may be required during specific operational cycles.

This invention also considers the geometric access limitations and includes a physical pathway for the removal of the individual units for maintenance and turn around. A turnaround being defined as a scheduled maintenance operational time period where the equipment is off line and maintained or modified.

A unique feature of the configurable systems described is the interconnection between units matching a specific pattern of geometric arrangement to allow the undisturbed flow while maintaining the functionality of the units and the considerations for off line short cycle removal for the functional operations required for the maintenance of the specific unit. Usually, maintenance operations for these types of functional units is either completed in place or with the full disassembly and removal of the unit without regard with the configurable and “plug and play” characteristic of the unit. The unique difference is the ability to assemble the units such that all interconnects follow a certain pattern. This rigorous geometric arrangement allows the functional assembly ad dis-assembly of the system without specifically having to re-arrange the unique interconnection pattern and geometric layout of the system.

In extracting targeted constituents from liquids and gasses. Liquids and gasses could be collectively described as fluids. The feedstock may come from various types of different locations. In one embodiment, as in the example of extracting lithium from brine, a feedstock source tie-in location may be a pond of collected flowback and production water. This pond will have a certain constituent make up dependent upon the details of the preprocessing occurring prior to placement of material in the pond.

Most targeted constituent extraction systems require the removal of certain impurities, also defined in this invention as the non-targeted constituents, in order to enable targeted constituent extraction. This invention adds certain reagent chemicals which when in combination with some of the constituents present in the feedstock material constituents and in combination with the characteristic conditions available, this combination prepares the collected feedstock for extraction by creating precipitates or by creating conditions in the fluid material that maintains the undesired constituents in a form such that they pass through the system without affecting the desired performance of the unit operation. Reagent chemicals could be exemplified, but are not limited to, List 1 and characteristic conditions could be exemplified, but are not limited to, List 2.

List 1—Reagent Chemicals

Sand

Lime

Bleach

Hydrochloric Acid

Diatomaceous Earth

Carbon

Industrial Hemp

Air

Chlorine

Oxygen

Ammonia

List 2—Characteristic Conditions

Temperature

Concentration

pH

Total Suspended Solids

Shear Rate

An embodiment example of the combinational effects of the listed constituents and characteristics could be, but is not limited to, the addition of lime at the rate of 1 wt % to 5 wt % of the liquid brine stream in combination with a high shear mixing system. This increases the fluid velocity at the share point, an example might be at the tip of an agitator or the abrupt change of direction of the fluid flow due to the geometry of the flow path, by a multiple of a 100 to 1000 from the usual flow shear experienced in the interconnecting piping or the fluid volume characteristics of an intermediate storage tank. The increase in shear combined with the addition of the reagent chemical, in this example lime, allows the constituents in the feedstock to react to a greater extent due to the increased surface area due to the smaller interacting particles and droplets, and combined with the higher probability of interaction due to the higher fluid velocity of the particles and droplets in the confined shear zone. This could be characterized by the fluid velocity at the measured shear point. For example, in a pipe a fluid velocity of 5 feet per second could be a reasonable expectation to describe the shear. At the increased and controlled shear point of this invention the fluid velocity could be increased to 700 feet per second which could be obtained by a reduction in the pipe diameter, or the addition of an in line high shear device that could include an impeller and shaft imparting mechanical energy into the flow at the shear point. Another method of imparting shear could be by including an ultrasonic device to impart energy into the fluid increasing the shear into a very high frequency energy equivalent to the analogous fluid velocity shear profile as described in feet per second, whereas the ultrasonic frequency would be described in cycles/sec or more commonly, Hertz. A third possible embodiment of adding shear to the fluid stream to meet the defined multiple above could be to use a cavitation device where the fluid is constrained in the flow path where a very short time cycle state change allows a cavitation bubble of gas to form which immediately collapses due to the physical arrangement of the flow path. When this cavitation bubble collapses, a great deal of impulse energy is imparted to the area at the shear point. This physical phenomenon is described using fluid velocity equivalents that also meet the defined increase in the ratio of shear at this point versus the normal flow of the fluid.

The high surface area, high interaction probability mixing conditions occurring in the shear zone fully utilizes the added chemical with a reduced required residence time thus increasing the performance of the system.

In conventional systems which do not make use of this unique and novel technique, it has been shown that much of the added reagent chemical is wasted due to its inability to present itself to the targeted constituent in the liquid or gas which it intended for its functional feature is to be acted upon. Other embodiment examples, in addition to the lime and high shear mixer in a tank combination described above, could be different arrangements of chemical constituents and characteristic conditions, and this invention is not limited to the described embodiment.

Only some of the impurities and other constituents in the system, whether they are solid phase or liquid phase separation processes, remain present in the fluid event after the above described aspect of the invention. In order to remove the remaining and or additional undesired constituents from the fluid that could impede the effective extraction of the desired targeted constituents many methods previously disclosed and obvious to those skilled in the art are available. The methods prepare the fluid by removing the undesired constituents through precipitation and solid liquid separation.

In this invention, the fluid is first prepared using oxidation and pH chemistry similarly cited in prior art, but it additionally develops a reducing species in situ by adding certain reducing agents that keep any still present impeding species of constituents in solution. This allows the system separation function to not be impeded by its flow through the extraction step.

This is in situ feature is made possible by the unique and novel approach of using one or more of the undesired non-targeted constituents that are present in the fluid as one of the species of materials, when combined with a suitable reducing species reagent, to form a material that keeps certain constituents from impeding the extraction of the desired targeted constituents.

Many chemical constituents that behave as flow aides are present in the production water and flow back water from which the extraction fluid feedstock could be derived. By careful application of the specific feedstock characterization of the fluids, specific conjugate species can be added to the fluid to allow the formation of reduced species of the possible impeding constituents. These reduced species will remain in solution and pass without effect through the extraction unit operations.

Alternatively, and additionally, the same concept is used to seed the precipitation and removal of undesired impeding species present in the fluid. Seed material is usually required to produce a filterable precipitate. Seed material is usually an additional reagent chemical of some type. In the same way that the reducing species that keep the undesired constituents dissolved in formed in situ using some of the chemistry present in the fluid, a precipitating species can also be formed.

The seed material is formed or added in the recycle stream to generate more seed in-situ to continue to build particles of a size that can be filtered from the unit's product stream. Examples of seed material either present or formed in-situ may be one of any from the list, but not limited to, List 3.

List 3—Constituent Chemicals

Sand

Lime

Bleach

Hydrochloric Acid

Diatomaceous Earth

Sodium Hydroxide

Lithium Hydroxide

Soda Ash

Perlite

Aluminasilicate

Ammonia

Ferric Chloride

Chlorine

Hydrogen Peroxide

Air

Oxygen

Steam

Industrial Hemp

Cannabis

Oxidizing Agents

Reducing Agents

The pattern of interconnection of the units will affect the specific shear dynamics needs for the invention. Specifically, the interconnect pattern must have feed materials to the unit and enter the unit at a specific location derived externally from the shear containment vessel. If the pattern is such that the materials enter at the same interconnection point pattern as defined by the need for common plug and play arrangement, then the shear pattern at the entry point must be uniquely derived such that the desired function, which could be precipitation particle formation, liquid droplet size management, or reaction rate acceleration, has to be applied to the specific material in the unit.

A three inch line entering horizontally at 5 feet per second of mass movement at the nozzle expansion where the inlet pipe connects to the wall of the tank, then to precipitate a particle, which requires a certain type of local interaction between the precipitation target and the precipitating reagent, might require a 50 rpm shaft speed from the agitator that has a 3 foot clearance from its tip to the nozzle expansion location. In comparison, a reaction rate acceleration function might require double or triple the shaft speed for the same unique geometric configuration. There are many unique combinations that exist from which specific functional results can be obtained. This invention outlines the various unique combinations so that the function derived needed parameters can be applied to the extraction of constituents from the brine.

A conventional packed bed extraction column is commonly a large diameter (on the order of 8 to 12 feet) column with an aspect ratio of usually 1 or 1.5 to 1 when comparing the diameter to the height. These columns can be sized using the superficial velocity of the fluid passing through the column as the limiting factor. Commonly a lower superficial velocity is desired. The lower superficial velocity allows the equilibrium to form between the fluid constituents and the functional material that retains or operates physically on the desired targeted constituent. The functional material in this case being particles that fill the large diameter column. This method and many material examples can be found throughout the chemical industry for many common purification systems. Larger diameter columns suffer from the possibility of mal-distribution of the chromatographic front that has the highest driving force for the mass transfer equilibrium in the system. A chromatographic front is where the concentration of the targeted constituent is sharply uniform and consistent across the surface area of the moving fluid mass as it moves as a unit along the flow pathway of the column. Mal-distribution is where the concentration gradient of the fluid passing through the column creates varying concentration profiles across the surface area of the “front” along the flow pathway. The larger the diameter, the greater the possibility of mal-distribution. To improve the design and to affect the problem of mal-distribution, this invention uses an array of small diameter columns arranged in such a way that the mal-distribution issues of the larger diameter low aspect ratio columns are not encountered. A stream containing a concentration of a targeted constituent is fed into an array of small diameter columns on the order of one fifth to one twentieth the diameter of conventional columns with a height to diameter ratio in the range of two to ten. The columns are arranged in a parallel flow array thus allowing a combined feed manifold and several parallel single elements arranged in the array to behave as one flow unit. This enables an extremely sharp concentration profile, thus a “sharp” chromatographic front to be presented to the extracting material in each of the single elements.

The performance of the column in any of these systems, whether conventional large diameter or the described invention of an array of high aspect ratio columns is described by the capacity of the column. The capacity is the mass of targeted constituent that can be retained by the internals of the packed bed column. A common value might be, but is not limited to, 2 grams of targeted constituent per liter of internal material. In these systems the physical operation is controlled by comparing the inlet concentration of the targeted constituent with the outlet concentration of the targeted constituent.

In packed bed column systems, several different liquid or gas streams bring feedstock to the columns by a system of interconnected piping. The control of the flow of a stream is accomplished by arranging various valves in the piping. Each time a valve is opened or closed the residual fluid from the just ran stream is combined locally at the valve with the next flow in the sequence that is presented to the column by the switching of the valves. Each time the valves switch a turbulent flow disturbance can occur and create a “back-mixing” effect which destroys the sharp interface between the two fluids. Usually the fluids have different densities and if a laminar flow characteristic is maintained, then the interface is not disturbed and the interface between the two fluids is presented to the column enabling a higher mass transfer driving force due to the higher difference in concentration of the targeted constituent between the two liquids in each of the two streams. If this laminar flow sharp interface can be introduced into the tank or high-volume area above the column internal material, then the column performance is improved.

This invention uses a high-volume shallow depth space above the array of columns that enables the equal distribution of a liquid containing dissolved targeted constituents. The array of small diameter extraction columns or the same “wide spot” concept across the diameter of a conventional large diameter column allows the sharp interface that was present in the piping arrangement near the valves to be maintained as the fluid transitions to the column system connected by the piping described. The concept for this invention is like that of a rain type shower head where the velocity of the fluid is low but the volume of fluid flowing through the device is high to enable similar flow mass rates without the usual high velocity disturbance to the fluid in the receiving tank or wide spot volume in the system. This arrangement uses a distribution system and an application of specifically arranged piping to allow even distribution of the fluid throughout the column or the array of columns. The unique and novel aspect of this invention includes the use of the hydraulic paradox. As the liquid interface will be controlled by the density of the fluids between the required cuts through each column, a narrow and tall area is placed on top of a wide and shallow area in the overhead piping. To ensure that there is no loss of the defined interface in the tall narrow area, the pressure in the transition area of the header is kept constant by a level-controlled tank above the narrow section of the header transition zone. This enables clean and sharp cuts as the different cuts flow through the system.

In conventional packed bed extraction systems, many different “cuts” or types of materials are produced using a sequence of different fluids to flow through the system. Some of these resulting materials contain concentrations of the targeted constituent that are too low to be of economic value and may be considered waste. This invention allows the product cut to be more dilute as compared to conventional methods for product cuts from extraction systems.

Allowing a product cut from the column to be more dilute than conventional systems enables the recovery of any targeted material constituent that may be lost due to the inability to recycle this dilute stream back into the system for recovery of the material.

In this case, and as part of this invention, a membrane is used to remove the solvent, in most cases water, from the stream containing the desired targeted constituent. A portion of the solvent permeates the membrane and the desired targeted constituent along with another portion of the solvent that is retained by the membrane.

Membranes are susceptible to materials building up on and “fouling” the membrane affecting the performance of the separation by reducing the flux of the permeate through the membrane. In this invention, both a purification membrane and a concentration membrane are used in series.

The purification membrane allows the solvent plus the targeted constituent to permeate the purification membrane thus removing some of the larger undesired non-targeted constituents. The purification membrane then permeates the portion of the solvent, concentrating the targeted constituent in the retained solvent that does not permeate the membrane.

In a typical embodiment, a cross flow membrane is used. Cross flow is a description used to identify the geometric arrangement of how the liquid is presented to the membrane. The cross-flow membrane allows the targeted constituent and solvent to pass, or permeate, as it rejects the undesired impurities.

An example could be the separation and concentration of lithium in a chloride brine as the targeted constituent and solvent with divalent cations, most commonly calcium and magnesium, being the undesired non-targeted constituents and rejected. Other constituent combinations exist. Purification membranes typically reduce the levels of impurities to the parts per million level and are operated at a pressure between 100 and 400 psig.

To complete this invention's purification and concentration of the targeted constituent the product stream that passed through the purification membrane is now fed into a system containing a concentration membrane.

In a concentration membrane, the solvent, most commonly water, passes through the membrane and the targeted constituent is rejected, thus it concentrates in the reject stream.

An embodiment of this concentrating membrane is reverse osmosis. Concentration membranes operated as reverse osmosis systems typically concentrate the targeted constituent to weight percentage levels. Concentration membranes operated as reverse osmosis systems are limited by the osmotic pressure of the solution and the practical limits of the pressure ratings of the single element components. Concentration membranes typically operate between 200 and 1200 psig.

Both the purification membrane units and the concentration membrane units are made up of single elements arranged in arrays. Like the extraction array, purification and concentration membrane units can be arranged in arrays and fitted to mobile systems. This allows the mobile deployment of these unit operations for recovery of targeted constituents.

The invention can include the collection of the purified and concentrated lithium rich brine for use in post extraction product conversion systems. These systems benefit from the purity of the lithium rich brine and the ability to avoid further raw purification processes to prepare the brine for unit operations including electrolysis, splitting and recovery. In some lithium extraction systems, the bed volume of displaced dilute stream can be recycled or pushed forward to the purification and concentration membrane units because the units can readily concentrate dilute and clean target constituent streams.

In the conventional method using selective sorbents, the strip solution is pushed for a limited number of bed volumes to capture a clean and concentrated stream of targeted constituent. The conventional method does not have the advantage of the purification and concentration membrane units and must stop the flow of strip solution when the targeted constituent falls below a concentration level.

This invention allows a greater number of bed volumes of strip solution to be run versus the limitations of the conventional sorbent columns. This method results in a higher mass of collected targeted material.

This material, known as the product cut, will be clean of impurities, but more dilute than the conventional method. Using this invention, the product cut from that operation, can be more dilute and can utilize the purification and concentration membrane techniques described.

Additionally, in the columns, the extraction material sites present in the column are more available from having the membrane system concentrate the targeted constituent by the fact that the recycled fluid resulting from the concentration membrane is of a higher concentration that would be if the technique was not used.

Membrane technology can also be applied in this invention to recover and isolate CO2 from a feed gas stream which could be simply air, ore as complex as a discharge from a power plant that would be present in the fluids that are processed in these operations.

The CO2 could be used to produce a possible final carbonate product by reacting the targeted constituent rich liquid or gas stream with the separated CO2.

In the case of Li2CO3 production, the purification and concentration system allows the direct conversion of the purified lithium chloride stream, with the lithium being the targeted constituent in this case, to the desired final product of lithium carbonate.

The purified product will meet the raw purification requirements and thus no longer requiring the usual secondary lithium carbonate purification system that is common when the traditional route of reacting lithium chloride with sodium carbonate is followed.

1. A method for separating undesirable constituents from desired constituents in a fluid for the preparation, extraction and concentration of the desired constituent comprising:
a. a method where a reagent chemical is added to a liquid or a gas in combination with setting characteristic conditions available in the system to prepare the fluid for extraction by removing undesired constituents from the feedstock so that the interconnected downstream operation can isolate and extract the desired targeted constituents using at least one of a multitude of reagent chemicals or reagent types where examples include: sand, lime, bleach, mineral acids, organic acids, caustics, diatomaceous earth, carbon, silicas, aluminas, industrial hemp, cannabis, air, oxygen, ammonia, chlorine, oxidizing agents, or reducing agents in combination with at least one of a multitude of characteristic conditions where examples include: temperature, pressure, concentration, pH, total suspended solids, shear rate, addition order, and flow history;
b. a method where a liquid or gas is prepared using first an oxidation step to precipitate at least one undesired constituent lowering the concentration level of the undesired constituent by removing the precipitate using a liquid/solid separation followed by introducing at least one reducing agent that will interact with one of the undesirable constituents in the liquid or gas to partially reduce the impeding species into a reduced species in situ with the resulting liquid or gas enabling the fluid to flow through the downstream operations of the system without effecting the performance of the system; and,
c. a method that uses a membrane arranged in a way that a portion of the continuous phase in the liquid or gas flow is removed so that it leaves behind a liquid or gas more concentrated in at least one targeted constituent with a flow pattern in the membrane system that maintains the fluid velocity such that any solid particles settling on the membrane or forming a film or gel on the membrane is at least partially scoured away and removed from the predetermined arrangement of the membrane flow cavities.

2. A method of claim 1 that partially separates CO2 from a gas stream and reacts it with a targeted constituent rich liquid or gas stream to produce a precipitated final carbonate product.

3. A method of claim 1 for calling for a plurality of unitized equipment with predetermined dimensions enabling the stand alone function of the unitized equipment itself allowing for the quick assembly of the units into a multicomponent interconnected system to perform a predetermined system function which is a combination of each unit's standalone function at a specific location such that the assembly, disassembly, maintenance and operations are not hindered by the predetermined framework into which the assembled system is constrained.

4. An apparatus that uses a large volume shallow depth tank containing a material that has an affinity for at least one targeted constituent in a fluid stream such that the flow of the fluid trickles or slowly percolates driven by atmospheric pressure above the liquid level and the liquid head pressure itself pushing the fluid through the interstitial spaces between the material that fills the tank where the equilibrium is established that allows the transfer of the mass of the targeted constituent contained in the fluid to the material that is contained in the tank while the fluid is maintaining an interface or a phase change between the forward fluid and the following fluid such that the functions of loading, stripping, washing, and regenerating material that retains and releases the targeted constituent on and off the material using an appropriate sequence can be accomplished in the system.

5. An array of interconnected small diameter columns with a height to diameter aspect ratio between 2 and 10 that maintains a sharp high constituent concentration difference chromatographic interface profile across the surface area of the flow path front between the different liquids being fed in sequence through the system.

6. A method of claim 5 using an apparatus that uses a large volume shallow depth tank hydraulically connected to and placed above or below a column or an array of several columns that are filled with a material that will partially retain at least one targeted constituent when contacted with the targeted constituent containing fluid.
